(19) United States
(12) Patent Application Publication
(10) Pub. No.: US 2008/0062322 A1
(43) Pub. Date: Mar. 13, 2008

(54) DIGITAL VIDEO CONTENT CUSTOMIZATION

(75) Inventors: Sujit Dey, La Jolla, CA (US); Debashis Panigrahi, La Jolla, CA (US); Douglas Wong, La Jolla, CA (US); Yusuke Takebuchi, La Jolla, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ortiva Wireless, La Jolla, CA (US)

(21) Appl. No.: 11/467,890

(22) Filed: Aug. 28, 2006

(51) Int. Cl. H04B 1/66; H04N 9/75; H04N 9/74; H04N 5/14; G06K 9/40; H04N 11/04; H04N 9/64; H04N 11/02; H04N 7/12

(52) U.S. Cl. 348/589; 348/592; 348/571; 382/260; 375/240.22; 375/240.03

(57) ABSTRACT

A set of customizing operations for digital content is determined in accordance with network condition of a current network communication channel between a content server and one or more receiving devices, wherein the digital content is provided by the content server for transport to the receiving device and includes multiple frames of digital video data. The set of customizing operations specify multiple sequences or paths of customized video data in accordance with available video frame rates, and a customized video data sequence is selected from among the specified multiple sequences of customized video data in accordance with estimated received video quality and network condition for each receiving device.

### BACKGROUND

1. Field of the Invention

The present invention relates to data communications and, more particularly, to processing digital content including video data for resource utilization.

2. Description of the Related Art

Data communication networks are used for transport of a wide variety of data types, including voice communications, multimedia content, Web pages, text data, graphical data, video data, and the like. Large data files can place severe demands on bandwidth and resource capacities for the networks and for the devices that communicate over them. Streaming data, in which data is displayed or rendered substantially contemporaneously with receipt, places even more demands on bandwidth and resources. For example, streaming multimedia data that includes video content requires transport of relatively large video data files from a content server and real-time rendering at a user receiving device upon receipt in accordance with the video frame rate, in addition to processing text and audio data components. Bandwidth and resource capacities may not be sufficient to ensure a satisfactory user experience when receiving the multimedia network communication. For example, if bandwidth is limited, or error conditions are not favorable, then a user who receives streamed multimedia content over a network communication is likely to experience poor video quality, choppy audio output, dropped connections, and the like.

Some systems are capable of adjusting digital content that is to be streamed over a network communication in response to network conditions and end user device capabilities at the time of sending the data. For example, video content may be compressed at a level that is adjusted for the available bandwidth or device capabilities. Such adjustments, however, are often constrained in terms of the nature of data that can be handled or in the type of adjustments that can be made. Video content is especially challenging, as video data is often resource-intensive and any deficiencies in the data transport are often readily apparent. Thus, current adjustment schemes may not offer a combination of content changes that are sufficient to ensure a quality video content viewing experience at the user receiving device.

It is known to perform run-time video customizing operations on frames of video data to assemble a group of consecutive frames into a video stream that has been optimized for trade-off between quantization level and frame selection as between intra-coded frames (P frames) and inter-coded frames (I frames). See, for example, V-SHAPER: An Efficient Method of Serving Video Streams Customized for Diverse Wireless Communication Conditions, by C. Taylor and S. Dey, in IEEE Communications Society, Proceedings of Globecomm 2004 (Nov. 29-Dec. 3, 2004) at 4066-4070. The V-SHAPER technique described in the publication makes use of distortion estimation techniques at the frame level. Estimated distortion is used to guide selection of quantization level and frame type for the video streams sent to receiving devices.

Video content continues to increase in complexity of content and users continue to demand ever-increasing levels of presentation for an enriched viewing experience. Such trends put continually increasing demands on data networks and on service providers to supply optimal video data streams given increasingly congested networks in the face of limited bandwidth.

It should be apparent that there is a need for processing of digital video content to provide real-time adjustment to the streamed data to ensure satisfactory viewing experience upon receipt. The present invention satisfies this need.

### SUMMARY

In accordance with the invention, a set of customizing operations for digital video content is determined for a current network communication channel between a content server and one or more receiving devices, wherein the digital content is provided by the content server for network transport to the receiving device and includes multiple frames of video data. To determine the set of customizing operations, the current network conditions of a network communication channel between a content server and a receiving device are first determined. The set of available customizing operations for the digital video content are determined next, wherein the set of available customizing operations specify combinations of customization categories and operation parameters within the customization categories, including available video frame rates for the receiving device, to be applied to the digital video content. For each set of possible customizing operations for each frame under consideration, an estimate of received video quality is made for the receiving device based on the determined current network conditions. A single one of the combinations of the available customizing operations is then selected in accordance with estimated received video quality for the receiving device. The available bandwidth of the channel is determined by checking current network conditions between the content server and the receiving device at predetermined intervals during the communication session. The customizing operations can be independently selected for particular communication channels to particular receiving devices. Thus, there is no need to create different versions of the video content for specific combinations of networks and receiving devices, and adjustments to the video content are performed in real time and in response to changes in the channel between the content server and the receiving device. The customized video content can be delivered to the receiving device as streaming video to be viewed as it is received or as a download file to be viewed at a later time. In this way, the customized video data can be accurately received at a desired combination of speed and fidelity to reach a desired level of quality-of-service for rendering and viewing, given the available resources for a specific receiving device and end user. The user at each receiving device thereby enjoys an optimal viewing experience.

In one aspect of the invention, the current network condition is determined by a network monitor that determines channel characteristics such as data transit times between the content server and receiving device (bandwidth) and accounting for any dropped packets between the server and receiving device (packet counting). The network monitor can be located anywhere on the network between the server and the receiving device. In another aspect, the set of customizing operations are determined by a Content Customizer that receives the video content from the content server and determines the combination of customizing operations, including adjustment to the video frame rate, in view of the available resources, such as available bandwidth. The Content Customizer can be responsible for determining the customizing operations and carrying them out on the video content it receives from the content server for transport to the user device, or the selected customizing operations can be selected by the Content Customizer and then communicated to the content server for processing by the server and transport of data to the receiving device.

Other features and advantages of the present invention will be apparent from the following description of the embodiments, which illustrate, by way of example, the principles of the invention.

### BRIEF DESCRIPTION OF THE DRAWINGS

FIG. 1 is a flow diagram of the processing operations performed by a system constructed in accordance with the present invention.

FIG. 2 is a block diagram of a processing system that performs the operations illustrated in FIG. 1.

FIG. 3 is a block diagram of a network configuration in which the FIG. 2 system operates.

FIG. 4 is a block diagram of the components for the Content Customizer illustrated in FIG. 2 and FIG. 3.

FIG. 5 is a flow diagram of the operations performed by the Content Customizer for determining a set of customizing operations to be performed on the source content.

FIG. 6 is a flow diagram of the operations by the Content Customizer for constructing a decision tree that specifies multiple sequences of customized video data.

FIGS. 7, 8, 9, and 10 illustrate the operations performed by the Content Customizer in pruning the decision tree according to which the customizing operations will be carried out.

FIG. 11 is a flow diagram of the operations by the Content Customizer for selecting a frame rate in constructing the decision tree for customizing operations.

FIG. 12 is a flow diagram of the operations by the Content Customizer for selecting frame type and quantization level in constructing the decision tree for customizing operations.

FIG. 13 is a flow diagram of pruning operations performed by the Content Customizer in constructing the decision tree for customizing operations.

### DETAILED DESCRIPTION

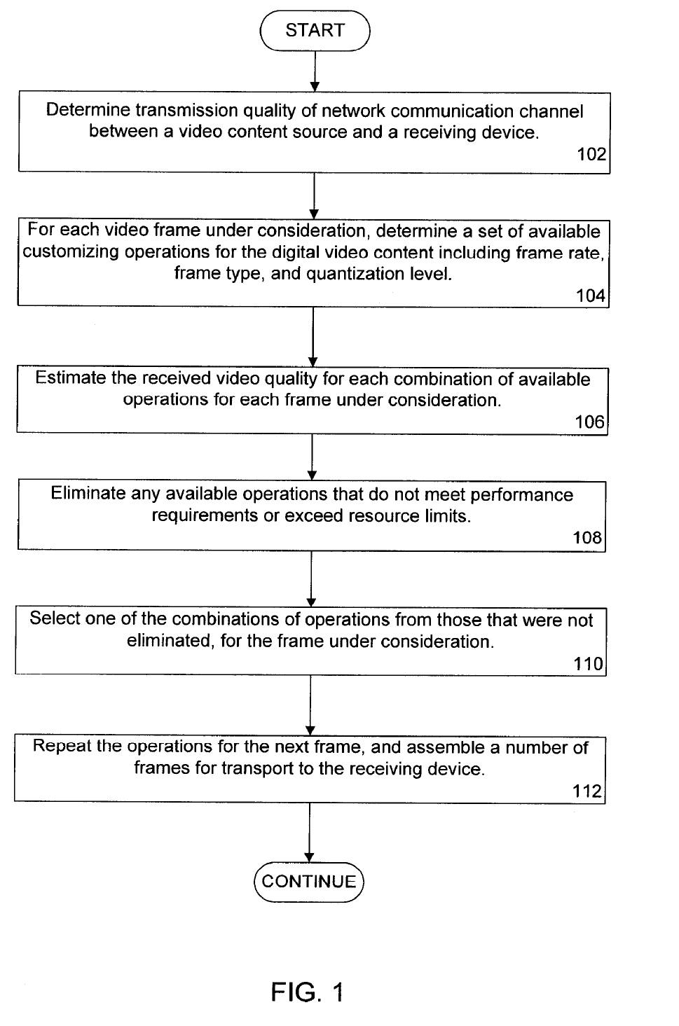

FIG. 1 is a flow diagram that shows the operations performed by a video content delivery system constructed in accordance with the present invention to efficiently produce a sequence of customized video frames for optimal received quality over a connection from a content server to a receiving device, according to the current network conditions over the connection. The operations illustrated in FIG. 1 are performed in processing selected frames of digital video content to produce customized frames that are assembled to comprise multiple sequences or paths of customized video data that are provided to receiving devices. For each user, the network conditions between content server and receiving device are used in selecting one of the multiple customized video paths to be provided to the receiving device for viewing.

The video customization process makes use of metadata information about the digital video content data available for customization. That is, the frames of video data are associated with metadata information about the frames. The metadata information specifies two types of information about the video frames. The first type of metadata information is the mean squared difference between two adjacent frames in the original video frame sequence. For each video frame, the metadata information specifies mean squared difference to the preceding frame in the sequence, and to the following frame in the sequence. The second category of information is the mean squared error for each of the compressed frames as compared to the original frame. That is, the video frames are compressed as compared to original frames, and the metadata information specifies the mean squared error for each compressed frame as compared to the corresponding original frame. The above metadata information is used in a quality estimation process presented later in this description. It is preferred that the digital video content data is available in a form such as VBR streams or frame sequences, with each stream being prepared by using a single quantization level or a range of quantization levels, such that each of the VBR frame sequences contain I-frames at a periodic interval. The periodicity of the I-frames determines the responsiveness of the system to varying network bandwidth.

FIG. 1 shows that in the first system operation, indicated by the flow diagram box numbered 102, the quality of transmission is determined for the network communication channel between the source of digital video content and each of the receiving devices. The quality of transmission is checked, for example, by means of determining transit times for predetermined messages or packets from the content source to the receiving device and back, and by counting dropped packets from source to receiving device and back. Other schemes for determining transmission quality over the network can be utilized and will be known to those skilled in the art. The network monitor function can be performed by a Network Monitor Module, which is described further below. The network monitor information thereby determines transmission quality for each one of the receiving devices that will be receiving customized video data.

In accordance with the invention, customizing operations are carried out frame by frame on the video content. For each frame, as indicated by the next box 104 in FIG. 1, a set of available customizing operations for the digital video content is determined. The available customizing operations will be selected from the set specifying frame rate for the video content, frame type for the frame, and quantization level for frame compression. The digital video content can come from any number of hosts or servers, and the sequences of customized video frames can be transported to the network by the originating source, or by content customizing modules of the system upon processing the digital content that it received from the originating source. The specification of customizing operations relating to frame type include specifying that the frame under consideration should be either a P-frame or an I-frame. The specification of quantization level can be specified in accordance with predetermined levels, and the specification of frame rate relates to the rate at which the digital video content frames will be sent to each receiving device for a predetermined number of frames. Thus, the result of the box 104 processing is a set of possible customizing operations in which different combinations of frame types, quantization levels, and frame rates are specified and thereby define multiple alternative operations on a frame of digital video data to thereby produce a customized frame of video data.

In the next operation at box 106, as estimate is produced of the received video quality for each combination of available customizing operations on the frame under consideration. Box 108 indicates that a pruning operation is performed based on estimated received quality, in which any available customizing operations that do not meet performance requirements (such as video frame rate) or that exceed resource limits (i.e. cost constraints) are eliminated from further consideration. It should be noted that the set of available customizing operations is evaluated for the current frame under consideration and also for a predetermined number of frames beyond the current frame. This window of consideration extends into the future so as to not overlook potential sequences or paths of customizing operations that might be suboptimal in the short term, but more efficient over a sequence of operations. As described more fully below, the box 108 operation can be likened to building a decision tree and pruning inefficient or undesired branches of the tree.

At box 110, the decision tree over the predetermined number of frames of customizing operations is processed to select one of the available sequences of customizing operations, the sequence that provides the best combination of estimated received video quality and low resource cost. Details of the quality estimation process are described further below. Lastly, at box 112, the determination of available customizing operations, estimate of received video quality, pruning, and selection are repeated for each frame in a predetermined number of frames, until all frames to be processed have been customized. The video processing system then proceeds with further operations, as indicated by the Continue box in FIG. 1. In this description, the sequence of customized frames for one of the receiving devices will be referred to as a path or stream of video content. As noted previously, however, the sequence of customized frames of video data can be rendered and viewed as a video stream in real time or can be received and downloaded for viewing at a later time.

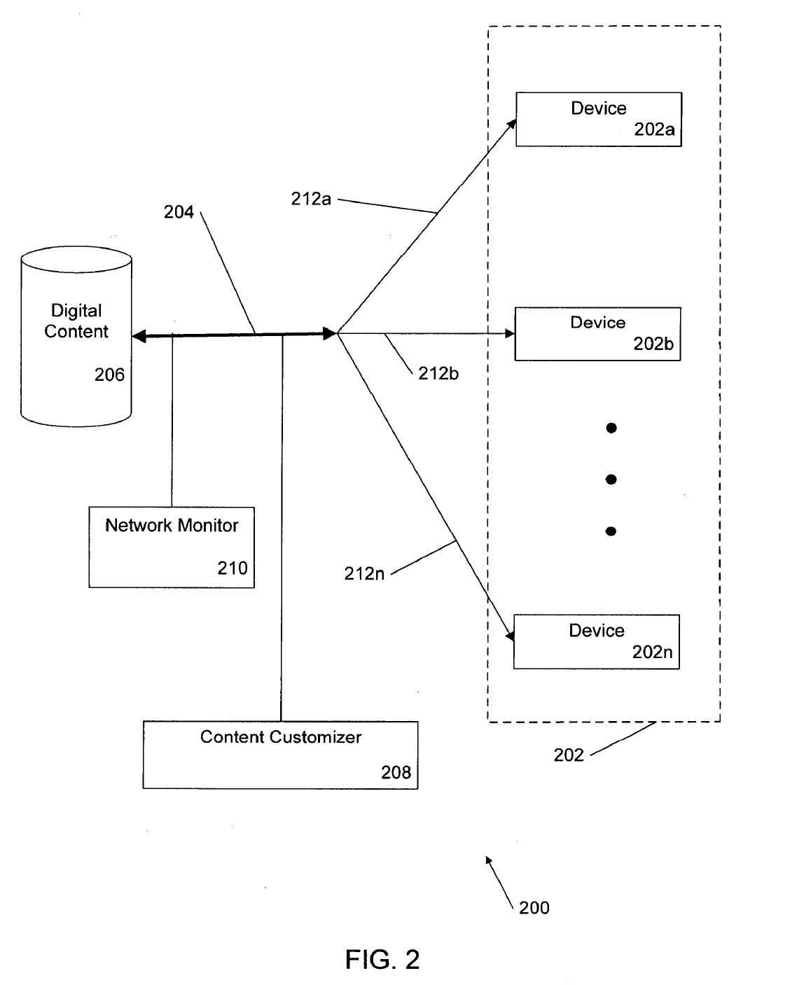

FIG. 2 is a block diagram of a processing system 200 constructed in accordance with the present invention to carry out the operations illustrated in FIG. 1. The block diagram of FIG. 2 shows that receiving devices 202 receive digital content including video content over a network connection 204. The digital content originates from a digital content source 206 and is customized in accordance with customizing operations selected by a Content Customizer 208. The receiving devices include a plurality of devices 202a, 202b, . . . , 202n, which will be referred to collectively as the receiving devices 202. For each one of the receiving devices 202a, 202b, . . . 202n, the Content Customizer determines a set of customizing operations that specify multiple streams or paths of customized video data in accordance with available video frame rates, and selects one of the customized video data paths in accordance with network conditions as a function of estimated received video quality. The current network conditions for each corresponding device 202a, 202b, . . . , 202n are determined by a network monitor 210 that is located between the content source 206 and the respective receiving device. The Content Customizer 208 can apply the selected customizing operations to the digital content from the content source 206 and can provide the customized video stream to the respective devices 202, or the Content Customizer can communicate the selected customizing operations to the content source, which can then apply the selected customizing operations and provide the customized video stream to the respective devices. In either case, the network monitor 210 can be located anywhere in the network between the content source 206 and the devices 202, and can be integrated with the Content Customizer 208 or can be independent of the Content Customizer.

The network devices 202a, 202b, . . . , 202n can comprise devices of different constructions and capabilities, communicating over different channels and communication protocols. For example, the devices 202 can comprise telephones, personal digital assistants (PDAs), computers, or any other device capable of displaying a digital video stream comprising multiple frames of video. Examples of the communication channels can include Ethernet, wireless channels such as CDMA, GSM, and WiFi, or any other channel over which video content can be streamed to individual devices. Thus, each one of the respective receiving devices 202a, 202b, . . . , 202n can receive a corresponding different customized video content sequence of frames 212a, 212b, . . . , 212n. The frame sequence can be streamed to a receiving device for real-time immediate viewing, or the frame sequence can be transported to a receiving device for file download and later viewing.

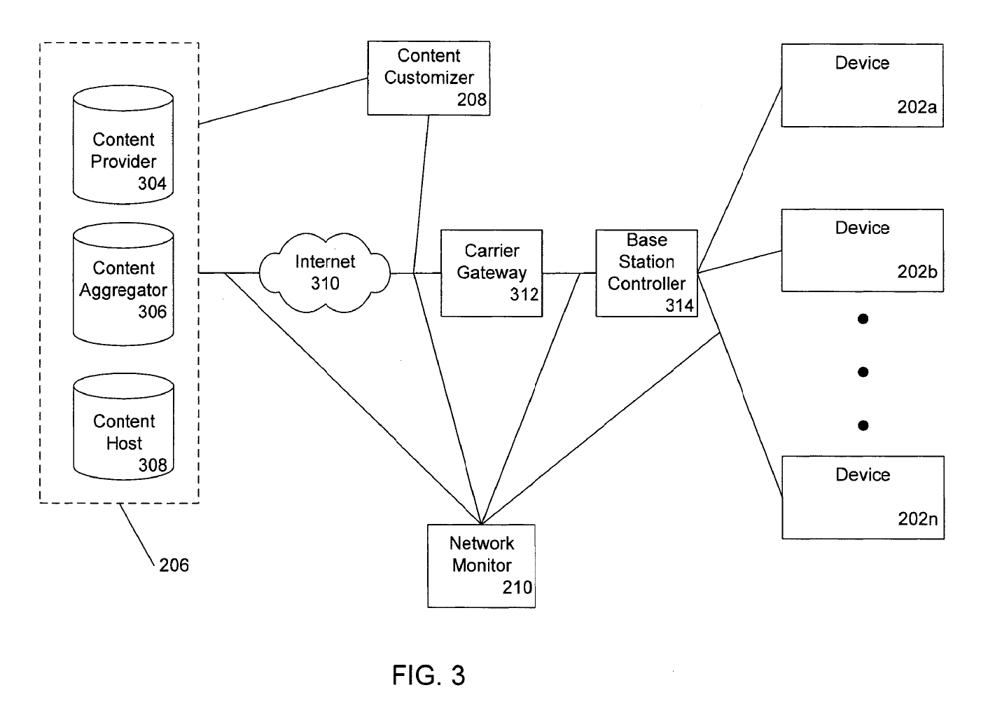

FIG. 3 is a block diagram of a network configuration 300 in which the FIG. 1 system operates. In FIG. 3, the receiving devices 202a, 202b, . . . , 202n receive digital content that originates from the content sources 206, which are indicated as being one or more of a content provider 304, content aggregator 306, or content host 308. The digital content to be processed according to the Content Customizer can originate from any of these sources 304 306, 308, which will be referred to collectively as the content sources 206. FIG. 3 shows that the typical path from the content sources 206 to the receiving devices 202 extends from the content sources, over the Internet 310, to a carrier gateway 312 and a base station controller 314, and then to the receiving devices. The communication path from content sources 206 to devices 202, and any intervening connection or subpath, will be referred to generally as the “network” 204. FIG. 3 shows the Content Customizer 208 communicating with the content sources 206 and with the network 204. The Content Customizer can be located anywhere in the network so long as it can communicate with one of the content sources 302, 304, 306 and a network connection from which the customized video content will be transported to one of the devices. That is, the carrier gateway 312 is the last network point at which the digital video content can be modified prior to transport to the receiving devices. Thus, FIG. 3 shows the Content Customizer communicating at numerous network locations, including directly with the content sources 206 and with the network prior to the gateway 312.

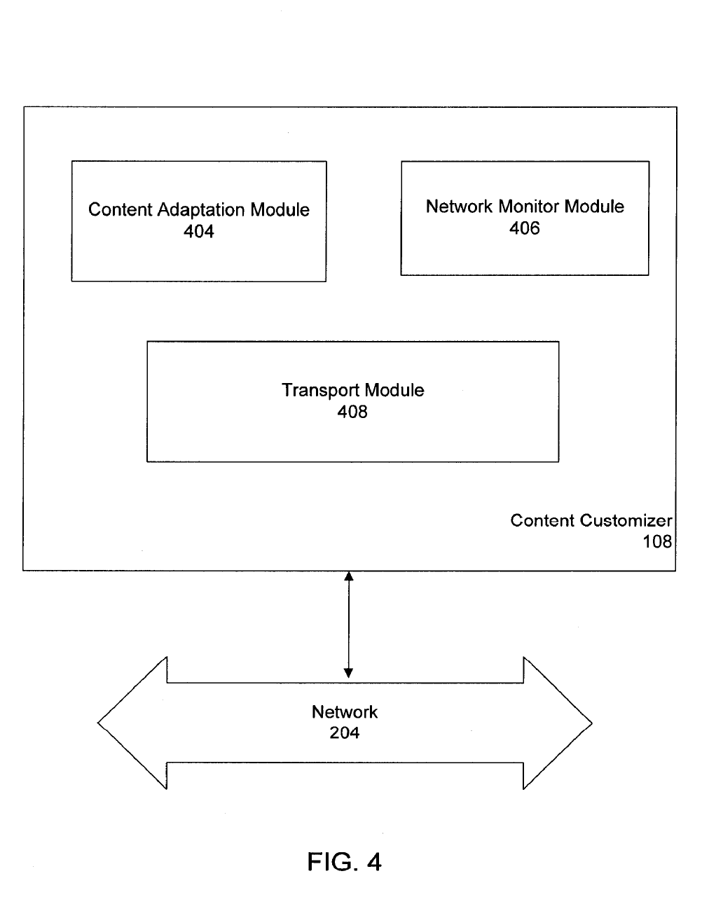

FIG. 4 is a block diagram of the components for the Content Customizer 208 illustrated in FIG. 2 and FIG. 3. FIG. 4 shows that the Content Customizer includes a Content Adaptation Module 404, an optional Network Monitor Module 406, and a Transport Module 408. The Network Monitor Module 406 is optional in the sense that it can be located elsewhere in the network 204, as described above, and is not required to be within the Content Customizer 208. That is, the Network Monitor Module can be independent of the Content Customizer, or can be integrated into the Content Customizer as illustrated in FIG. 4. The Transport Module 408 delivers the customized video content to the network for transport to the receiving devices. As noted above, the customized content can be transported for streaming or for download at each of the receiving devices.

The Network Monitor Module 406 provides an estimate of current network condition for the connection between the content server and any single receiving device. The network condition can be specified, for example, in terms of available bandwidth and packet drop rate for a network path between the content server and a receiving device. One example of the network monitoring technique that can be used by the Network Monitor Module 406 is for monitoring at the IP-layer by using packet-pair techniques. As known to those skilled in the art, in packet-pair techniques, two packets are sent very close to each other in time to the same destination, and the spread between the packets as they make the trip is observed to estimate the available bandwidth. That is, the time difference upon sending the two packets is compared to the time difference at receiving the packets, or comparing the round trip time from the sending network node to the destination node and back again. Similarly, the packet drop rate can be measured by counting the number of packets received in ratio to the number of packets sent. Either or both of these techniques can be used to provide a measure of the current network condition, and other condition monitoring techniques will be known to those skilled in the art.

The Content Adaptation Module 404 customizes the stream (sequence of frames) for the receiving device based on the network information collected by the Network Monitor Module 406 using the techniques described herein. The Transport Module 408 is responsible for assembling or stitching together a customized stream (sequence of frames) based on the decisions by the Content Adaptation Module and is responsible for transferring the assembled sequence of customized frames to the receiving device using the preferred mode of transport. Examples of transport modes include progressive downloads such as by using the HTTP protocol, RTP streaming, and the like.

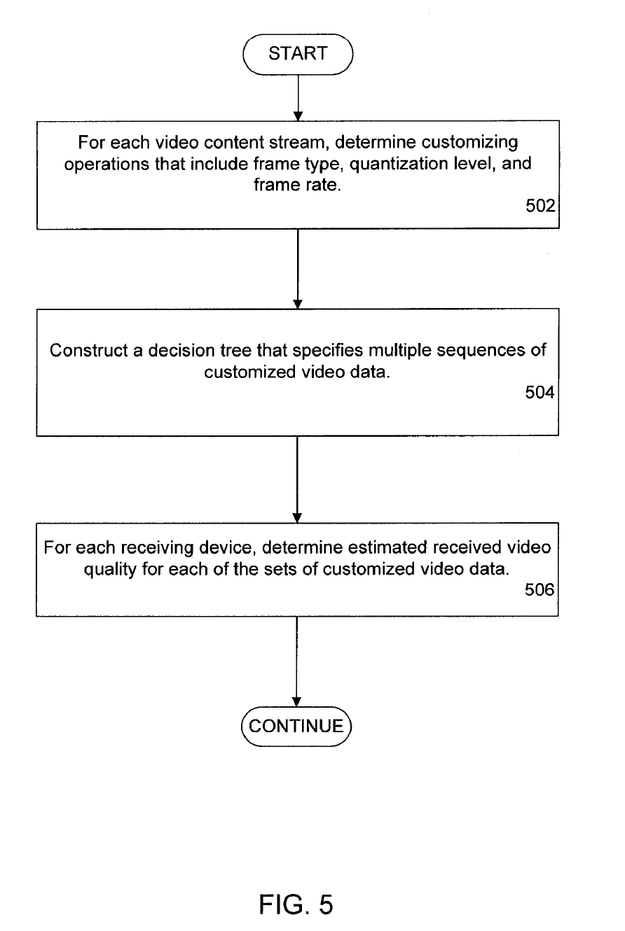

FIG. 5 is a flow diagram of the operations performed by the Content Customizer for determining the set of customizing operations that will be specified for a given digital video content stream received from a content source. In the first operation, indicated by the box 502 in FIG. 5, customizing operations are determined to include one or more selections of frame type, data compression quantization level, and frame rate. For example, most video data streams are comprised of frames at a predetermined frame rate, typically 3.0 to 15.0 frames per second (fps), and can include a mixture of I-frames (complete frame pixel information) and P-frames (information relating only to changes from a preceding frame of video data). Quantization levels also will typically be predetermined at a variety of compression levels, depending on the types of resources and receiving devices that will be receiving the customized video streams. That is, the available quantization levels for compression are typically selected from a predetermined set of available discrete levels, the available levels are not infinitely variable between a maximum and minimum value.

Thus, for the types of resources and devices available, the Content Customizer at box 502 determines which frame types, quantization levels, and frame rates can be selected to specify the multiple data streams from which the system will make a final selection. That is, the Content Customizer can select from among combinations of the possible frame types, such as either P-frames or I-frames, and can select quantization levels based on capabilities of the channel and the receiving device, and can select frame rates for the transmission, in accordance with a nominal frame rate of the received transmission and the frame rates available in view of channel conditions and resources.

At box 504, for each receiving device, the Content Customizer constructs a decision tree that specifies multiple streams of customized video data in accordance with the available selections from among frame types, quantization levels, and frame rates. The decision tree is a data structure in which the multiple data streams are specified by different paths in the decision tree.

After the multiple streams of customized data (the possible paths through the decision tree) are determined, the Content Customizer estimates the received video quality at box 506. The goal of the quality estimation step is to predict the video quality for each received frame at the receiving device. The received video quality is affected mainly by two factors: the compression performed at the content server prior to network transport, and the packet losses in the network between the content server and the receiving device. It is assumed that the packet losses can be minimized or concealed by repeating missed data using the same areas of the previous image frame. Based on the above assumptions, the Quality of Frame Received (Q_{REC}), measured in terms of Mean Squared Error (MSE) in pixel values, is calculated as the weighted sum of Loss in Quality in Encoding (QL_{ENC}) and Loss in Transmission (QL_{TRAN}), where P is the probability of packet error rate, given by the following Equation (1):

Q_{REC}=(1−P)*QL_{ENC}+P*QL_{TRAN} Eq. (1)

In Equation (1), QL_{ENC} is measured by the MSE of an I-frame or a P-frame while encoding the content. For an I-frame, QL_{TRAN} is the same as QL_{ENC} whereas for a P-frame the transmission loss is computed based on a past frame. The QL_{TRAN} is a function of the Quality of the last frame received and the amount of difference between the current frame and the last frame, measured as Mean Squared Difference (MSD). In order to compute the relationship between QL_{TRAN}, Q_{REC} of the last frame, and the MSD of the current frame, simulations are conducted and results are captured in a data table. After the data table has been populated, a lookup operation is performed on the table with the input of Q_{REC} of the last frame and MSD of the current frame to find the corresponding value of QL_{TRAN} in the table. In case of a skipped frame, the probability of a drop is set to 1.0 and QL_{TRAN} is computed using the MSD between the current frame and the frame before the skipped frame. When the quality estimation processing is completed, the system continues with other operations.

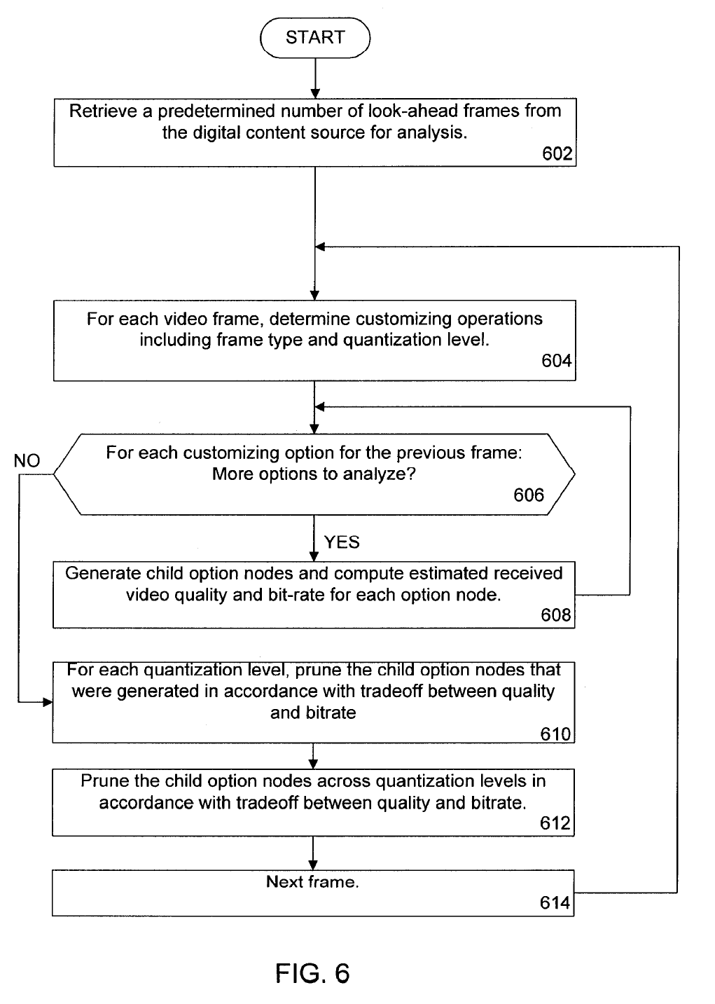

FIG. 6 is a flow diagram of the operations for constructing a decision tree that explores multiple options to create a customized sequence of video frames. In the first operation, indicated by the flow diagram box numbered 602, the Content Customizer retrieves a predetermined number of frames of the digital video content from the sources for analysis. For example, a look-ahead buffer can be established of approximately “x” frames of data or “y” minutes of video presentation at nominal frame rates. The buffer length can be specified in terms of frames of video or minutes of video (based on a selected frame rate). For each video content stream, the Content Customizer determines the customizing operations as noted above. The customizing operations are then applied to the buffered digital content data, one frame at a time, for each of the customizing operations determined at box 602.

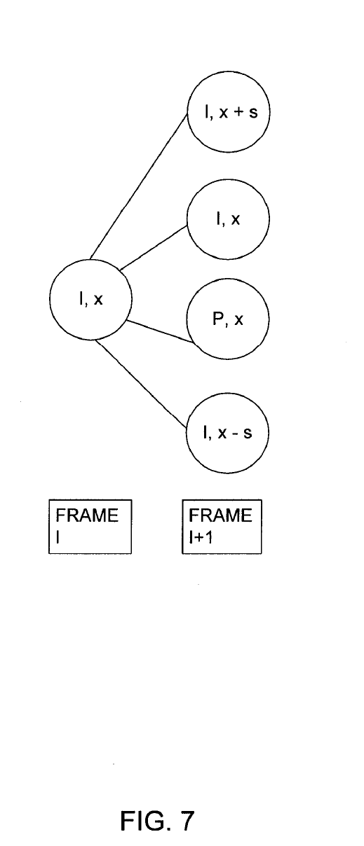

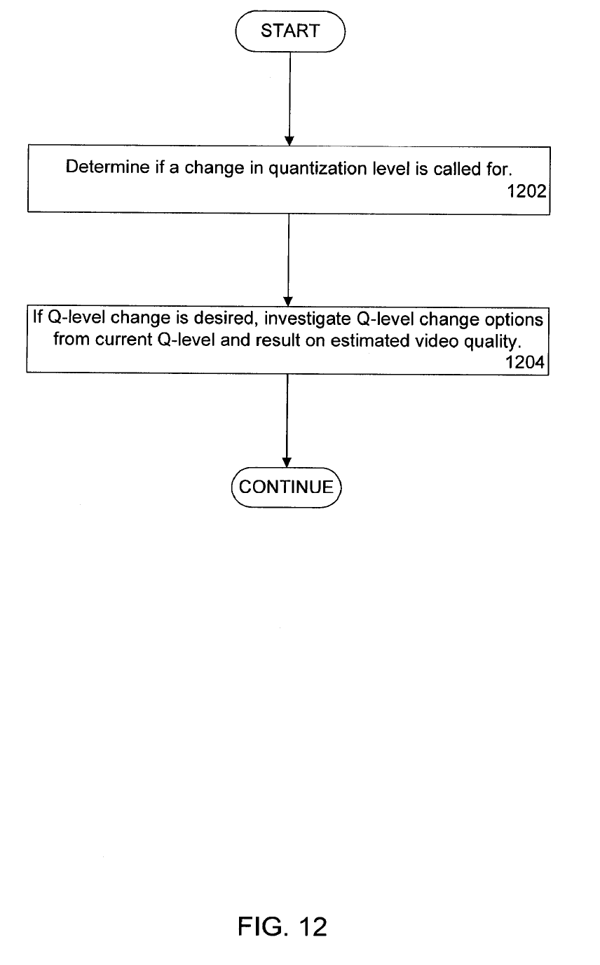

For each frame, the set of customizing options to be explored is determined at box 604. For example, as shown in FIG. 7, based on the previous frame in the frame sequence, shown as an I-frame at quantization level x enclosed in the circle above “Frame I”, four options are explored for the next frame in the sequence. The options are shown as comprising an I-frame at the same quantization level x as Frame I (indicated by I, x in a circle) and a P-frame at the same quantization level x (indicated by P, x), an I-frame at quantization level x+s, and an I-frame at quantization level x-s. The quantization level of a P-frame cannot be changed from the quantization level of the immediately preceding frame. The operations involved in exploring the desired quantization level are described further below in conjunction with the description of FIG. 12.

In the decision tree of FIG. 7, the value of “s” is determined by the difference between the current bitrate and the target bitrate. For example, one formula to generate an “s” value can be given by Equation (2):

s=min(ceil(abs(current bitrate−target bitrate/current bitrate)/0.1, 3). Eq. (2)

In Equation (2), the current bitrate is “x” and the target bitrate is determined by the Content Adaptation Module, in accordance with network resources. Based on the options to be explored, child nodes are generated, shown in box 608 of FIG. 6 by computing the estimated received video quality based on the current frame and the past frame, and the bitrate is computed as the average bitrate from the root of the tree. As each child node is added to the decision tree, the estimated received quality and the bitrate are calculated, as well as a cost metric for the new node.

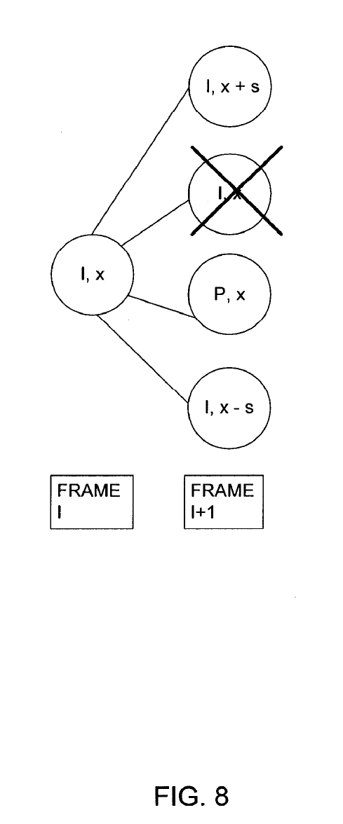

Thus, at box 606, the Content Customizer checks to determine if all shaping options have been considered for a given frame. If all shaping options have already been performed, a “NO” response at box 606, then the next frame in the stream will be processed (box 614) and processing will return to box 604. If one or more customizing options remain to be investigated, such as another bitrate for frame transport, a “YES” response at box 606, then the Content Customizer processes the options at box 608, beginning with generating child option nodes and computing estimated received video quality for each option node. In this way, the Content Customizer generates child option nodes from the current node. At box 610, child option nodes in the decision tree are pruned for each quantization level. At box 612, the child option nodes are pruned across quantization levels. The two-step pruning process is implemented to keep representative samples from different quantization levels under consideration while limiting the number of options to be explored in the decision tree to a manageable number. An exemplary sequence of pruning is demonstrated through FIGS. 8, 9, and 10.

FIG. 8 shows an operation of the pruning process. The “X” through one of the circles in the right column indicates that the customizing operation represented by the circle has been eliminated from further consideration (i.e., has been pruned). The customizing options are eliminated based on the tradeoff between quality and bitrate, captured using RD optimization where each of the options has a cost, which is computed with an equation given by

Cost=Distortion(Quality)+lambda*bitrate Eq. (3)

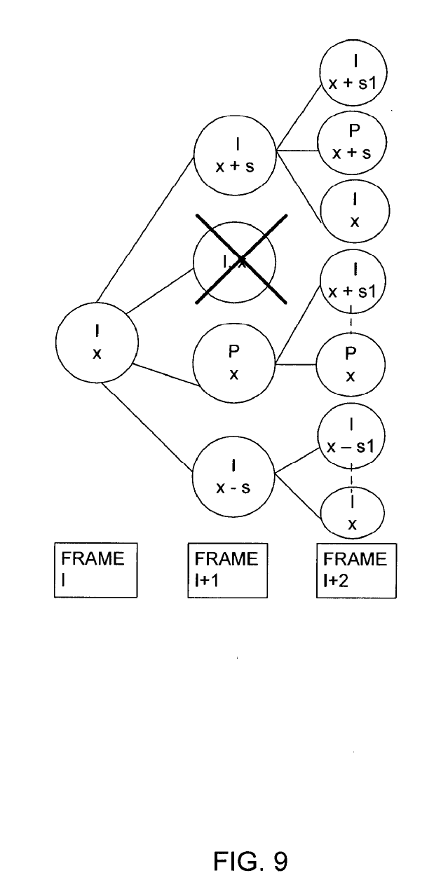

That is, a resource cost associated with the frame path being considered is given by Equation (3) above. The path options are sorted according to the cost and the worst options are pruned from the tree to remove them from further exploration. Thus, FIG. 8 shows that, for the next frame (I+1) following the current frame (I) having parameters of (I, x), the option path circle with (I, x) has an “X” through it and has been eliminated, which indicates that the Content Customizer has determined that the parameters of the next frame (I+1) must be changed. As a result, when the customizing operations to the second following frame (I+2) are considered, the options from this branch of the decision tree will not be considered for further exploration. This is illustrated in FIG. 9, which shows the decision tree options for the second following frame, Frame I+2 in the right hand column.

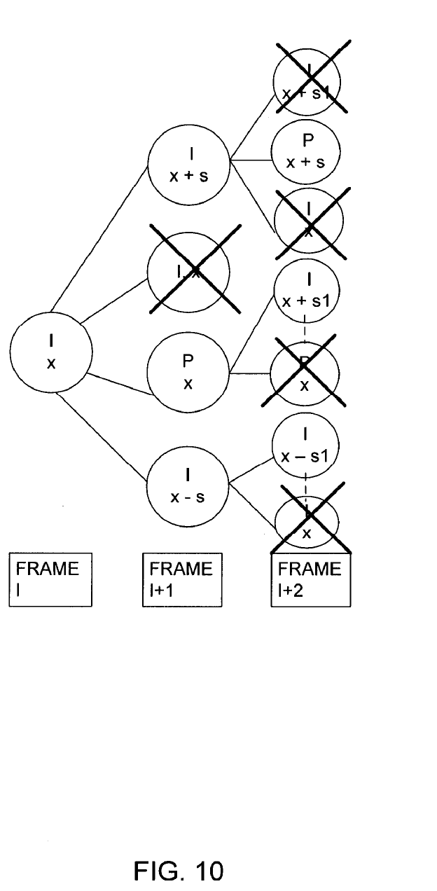

FIG. 9 shows that for the Frame I+1 path option comprising an I-frame at quantization level x+s, the next available options include another I-frame at quantization x+s1 (where s1 represents an increase of one quantization level from the prior frame), or another I-frame at quantization level x (a decrease of one quantization level from the then-current level), or a P-frame at quantization level x+s (no change in quantization level). Changing from an I-frame to a P-frame requires holding the quantization level constant. FIG. 10 shows that the set of options for the next frame, Frame I+2, do not include any child nodes from the (I, x) path of FIG. 9. FIG. 10 also shows that numerous option paths for the Frame (I+2) have been eliminated by the Content Customizer. Thus, three paths are still under consideration from Frame (I) to Frame (I+1) to Frame (I+2), when processing for Frame (I+3) continues (not shown).

Thus, the pruning operations at box 610 and 612 of FIG. 6 serve to manage the number of frame paths that must be considered by the system, in accordance with selecting frame type and quantization level. After pruning for frames is completed, the system continues with further operations.

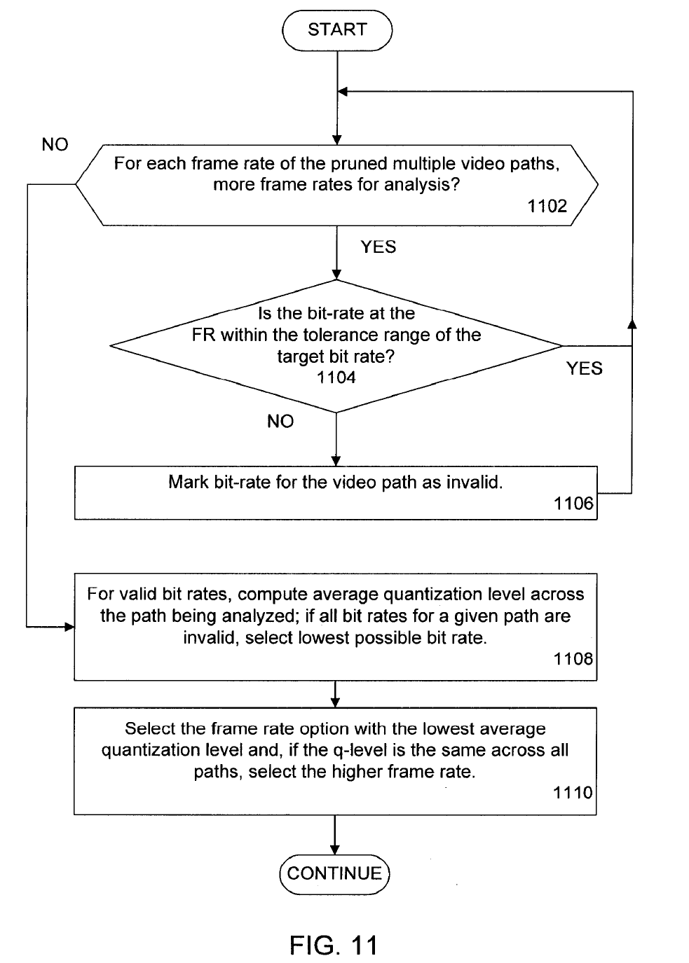

FIG. 11 is a flow diagram of the operations for selecting a frame rate in constructing the decision tree for customizing operations. In selecting a frame rate from among the multiple sequences or paths of customized video content, FIG. 11 shows how the Content Customizer checks each of the available frame rates for each path. For a given sequence or path in the decision tree, if more frame rates remain to be checked, a “YES” outcome at box 1102, then the Content Customizer checks at box 1104 to determine if the bitrate at the current frame rate is within the tolerance range of the target bitrate given by the Network Monitor Module. If the bitrate is not within the target bitrate, a “NO” outcome at box 1104, then the bitrate for the path is marked as invalid at box 1106, and then processing is continued for the next possible frame rate at box 1102. If the bitrate is within the target, a “YES” outcome at box 1104, then the bitrate is not marked as invalid and processing continues to consider the next frame rate, with a return to box 1102.

If there are no more frame rates remaining to be checked for any of the multiple path options in the decision tree, a negative outcome at box 1102, then the Content Customizer computes average quantization level across the path being analyzed for each valid bitrate. If all bitrates for the path were marked as invalid, then the Content Customizer selects the lowest possible bitrate. These operations are indicated at box 1108. At box 1110, the Content Customizer selects the frame rate option with the lowest average quantization level and, if the quantization level is the same across all of the analyzed paths, the Content Customizer selects the higher frame rate.

As noted above, the pruning operation involves exploring changes to quantization level. FIG. 12 is a flow diagram of the operations for selecting frame type and quantization level in performing pruning as part of constructing the decision tree for customizing operations. At box 1202, the Content Customizer determines if a change in quantization level is called for. Any change in quantization level requires a I-frame as the next video frame of data. Therefore, the change in quantization level has a concomitant effect on processing cost and resource utilization. A change in quantization level may be advisable, for example, if the error rate of the network channel exceeds a predetermined value. Therefore, the Content Customizer may initiate a change in quantization level in response to changes in the network channel, as informed by the Network Monitor Module. That is, an increase in dropped packets or other indictor of network troubles will result in greater use of I-frames rather than P-frames,

At box 1204, if a change in quantization level is desired, then the Content Customizer investigates the options for the change and determines the likely result on the estimate of received video quality. The options for change are typically limited to predetermined quantization levels or to incremental changes in level from the current level. There are two options for selecting a change in quantization level. The first quantization option is to select an incremental quantization level change relative to a current quantization level of the video data frame. For example, the system may be capable of five different quantization levels. Then any change in quantization level will be limited to no change, an increase in one quantization level, or a decrease of one quantization level. The number of quantization levels supported by the system can be other than five levels, and system resources will typically govern the number of quantization levels from which to choose. The second quantization option is to select a quantization range in accordance with a predetermined maximum quantization value and a predetermined minimum quantization value. For example, the system may directly select a new quantization level that is dependent solely on the network conditions (but within the maximum and minimum range) and is independent of the currently set quantization level. The Content Customizer may be configured to choose the first option or the second option, as desired. This completes the processing of box 1204.

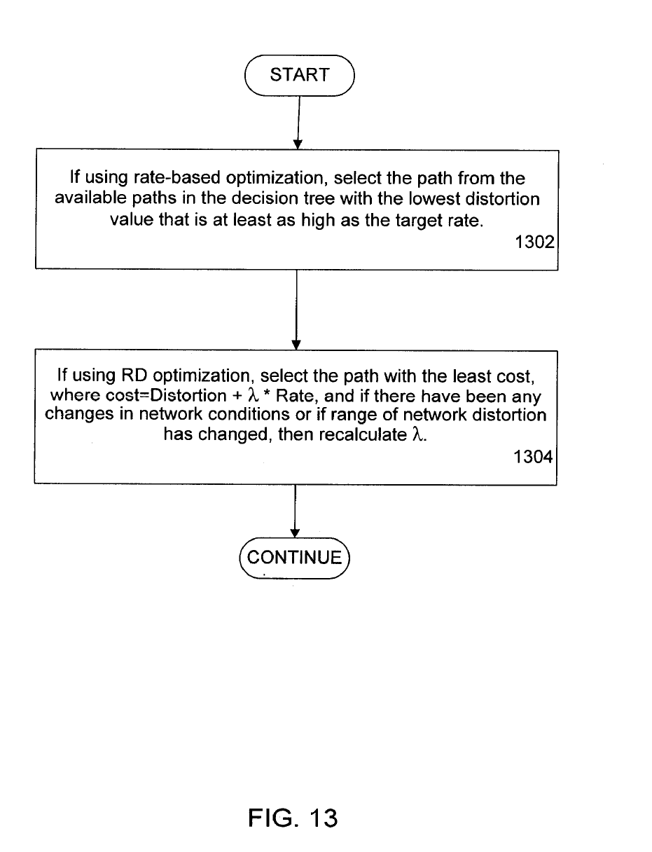

As noted above, a cost associated with each option path through the decision tree is calculated, considering distortion and bitrate as given above by Equation (3). Thus, after all pruning operations are complete, the system can select one path from among all the available paths for the network connection to a particular receiving device. Such selection is represented in FIG. 1 as box 110. Details of the cost calculation performed by the system in determining cost for a path can are illustrated in FIG. 13.

FIG. 13 shows that rate-based optimization can be followed, or RD optimization can be followed. The system will typically use either rate-based or RD optimization, although either or both can be used. For rate-based operation, the processing of box 1302 is followed. As indicated by box 1302, rate-based optimization selects a path based on lowest distortion value for the network connection. The RD optimization processing of box 1304 selects a path based on lowest cost, according to Equation (3). The lambda value in Equation (3) is typically recalculated when a change in network condition occurs. Thus, when the Content Adaptation Module (FIG. 4) is informed by the Network Monitor of a network condition change, the Content Adaptation Module causes the lambda value to be recalculated. Changes in network condition that can trigger a recalculation include changes in network bandwidth and changes in distortion (packet drops).

The recalculation of lambda value considers network condition (distortion) and bitrate according to a predetermined relationship. Those skilled in the art will understand how to choose a new lambda value given the distortion-bitrate relationship for a given system. In general, a new lambda value L_{NEW} can be satisfactorily calculated by Equation (4) below:

L_{NEW}=L_{PREV}+1/5*(BR_{PREV}−BR_{NEW}/BR_{NEW})*L_{PREV} Eq. (4)

where L_{PREV} is the previous lambda value and BR is the bitrate.

The devices described above, including the Content Customizer 208 and the components providing the digital content 206, can be implemented in a wide variety of computing devices, so long as they can perform the functionality described herein. Such devices will typically operate under control of a computer central processor and will include user interface and input/output features. A display or monitor is typically included for communication of information relating to the device operation. Input and output functions are typically provided by a user keyboard or input panel and computer pointing devices, such as a computer mouse, as well as ports for device communications and data transfer connections. The ports may support connections such as USB or wireless communications. The data transfer connections may include printers, magnetic and optical disc drives (such as floppy, CD-ROM, and DVD-ROM), flash memory drives, USB connectors, 802.11-compliant connections, and the like. The data transfer connections can be useful for receiving program instructions on program product media such as floppy disks and optical disc drives, through which program instructions can be received and installed on the device to provide operation in accordance with the features described herein.

The present invention has been described above in terms of presently preferred embodiments so that an understanding of the present invention can be conveyed. There are, however, many configurations for video data delivery systems not specifically described herein but with which the present invention is applicable. The present invention should therefore not be seen as limited to the particular embodiments described herein, but rather, it should be understood that the present invention has wide applicability with respect to video data delivery systems generally. All modifications, variations, or equivalent arrangements and implementations that are within the scope of the attached claims should therefore be considered within the scope of the invention.

We claim:

1. A method of processing digital video content, the method comprising:
determining network conditions of a current network communication channel between a content server and a receiving device;
determining a set of available customizing operations for the digital video content, wherein the digital video content is provided by the content server for network transport to the receiving device and includes one or more frames of video data, and wherein the set of available customizing operations specify combinations of operation categories and operation parameters within the operation categories, including available video frame rates for the receiving device, to be applied to the digital video content;
estimating received video quality for each of the combinations of the available customizing operations for the receiving device based on the determined network conditions;
selecting a single one of the combinations of the available customizing operations in accordance with estimated received video quality for the receiving device.

2. The method as defined in claim 1, wherein the operations of determining, estimating, and selecting are repeated for each frame of the digital video content.

3. The method as defined in claim 1, wherein the operation categories include frame type, quantization level, and frame rate for the digital video content.

4. The method as defined in claim 1, wherein the frames of video data are associated with metadata information about the frames.

5. The method as defined in claim 4, wherein the metadata information specifies the mean squared difference between two adjacent frames of the video data.

6. The method as defined in claim 4, wherein the frames of video data comprise frames compressed with respect to original frames, and the metadata information specifies the mean squared error for each compressed frame as compared to the corresponding original frame.

7. The method as defined in claim 1, further including:
constructing a decision tree with nodes that specify the combinations of operation categories and operation parameters within the operation categories; and
determining estimated received video quality for each of the decision tree nodes.

8. The method as defined in claim 7, wherein constructing a decision tree comprises analyzing the available customizing operations for each video data frame of the digital video content by means of operations comprising:
generating child nodes comprising option nodes for the available customizing operations;
pruning the child nodes in accordance with quantization level.

9. The method as defined in claim 8, wherein pruning includes pruning the child nodes in accordance with incremental quantization level relative to a current quantization level of the video data frame.

10. The method as defined in claim 8, wherein pruning includes pruning the child nodes in accordance with a range of quantization level of the available customizing operations for the video data frame.

11. The method as defined in claim 1, wherein estimating received video quality comprises consideration of frame type, including video P-frames and I-frames.

12. The method as defined in claim 11, further including consideration of encoding distortion of the P-frames and I-frames.

13. The method as defined in claim 1, wherein estimating received video quality comprises consideration of frame rate.

14. The method as defined in claim 13, wherein the available customizing operations include skipping a video data frame in the digital video content.

15. A digital video content delivery apparatus comprising:
a network monitor module that determines available bandwidth of a current network communication channel between a content server and a receiving device;
a Content Customizer for processing digital content that is provided by the content server for network transport to the receiving device and that includes multiple frames of video data, wherein the Content Customizer determines a set of available customizing operations for the digital video content, wherein the digital video content includes one or more frames of video data, and wherein the set of available customizing operations specify combinations of operation categories and operation parameters within the operation categories, including available video frame rates for the receiving device, to be applied to the digital video content, and estimates received video quality for each of the combinations of the available customizing operations for the receiving device based on the determined network conditions, and selects a single one of the combinations of the available customizing operations in accordance with estimated received video quality for the receiving device.

16. The apparatus as defined in claim 15, wherein the Content Customizer operations of determining, estimating, and selecting are repeated for each frame of the digital video content.

17. The apparatus as defined in claim 15, wherein the Content Customizer operation categories include frame type, quantization level, and frame rate for the digital video content.

18. The apparatus as defined in claim 15, wherein the frames of video data are associated with metadata information about the frames.

19. The apparatus as defined in claim 18, wherein the metadata information specifies the mean squared difference between two adjacent frames of the video data.

20. The apparatus as defined in claim 18, wherein the frames of video data comprise frames compressed with respect to original frames, and the metadata information specifies the mean squared error for each compressed frame as compared to the corresponding original frame.

21. The apparatus as defined in claim 15, wherein the Content Customizer further constructs a decision tree with nodes that specify the combinations of operation categories and operation parameters within the operation categories, and determines estimated received video quality for each of the decision tree nodes.

22. The apparatus as defined in claim 21, wherein constructing a decision tree comprises analyzing the available customizing operations for each video data frame of the digital video content by means of operations comprising:
generating child nodes comprising option nodes for the available customizing operations;
pruning the child nodes in accordance with quantization level.

23. The apparatus as defined in claim 22, wherein pruning includes pruning the child nodes in accordance with incremental quantization level relative to a current quantization level of the video data frame.

24. The apparatus as defined in claim 22, wherein pruning includes pruning the child nodes in accordance with a range of quantization level of the available customizing operations for the video data frame.

25. The apparatus as defined in claim 15, wherein estimating received video quality comprises consideration of frame type, including video P-frames and I-frames.

26. The apparatus as defined in claim 25, further including consideration of encoding distortion of the P-frames and I-frames.

27. The apparatus as defined in claim 15, wherein estimating received video quality comprises consideration of frame rate.

28. The apparatus as defined in claim 27, wherein the available customizing operations include skipping a video data frame in the digital video content.

29. A program product for use in a computer system that executes program instructions recorded in a computer-readable media to perform a method for processing digital video content, the program product comprising:
a recordable media;
a program of computer-readable instructions executable by the computer system to perform operations comprising:
determining network conditions of a current network communication channel between a content server and a receiving device;
determining a set of available customizing operations for the digital video content, wherein the digital video content is provided by the content server for network transport to the receiving device and includes one or more frames of video data, and wherein the set of available customizing operations specify combinations of operation categories and operation parameters within the operation categories, including available video frame rates for the receiving device, to be applied to the digital video content;
estimating received video quality for each of the combinations of the available customizing operations for the receiving device based on the determined network conditions;
selecting a single one of the combinations of the available customizing operations in accordance with estimated received video quality for the receiving device.

30. The program product as defined in claim 29, wherein the operations of determining, estimating, and selecting are repeated for each frame of the digital video content.

31. The program product as defined in claim 29, wherein the operation categories include frame type, quantization level, and frame rate for the digital video content.

32. The program product as defined in claim 29, wherein the frames of video data are associated with metadata information about the frames.

33. The program product as defined in claim 32, wherein the metadata information specifies the mean squared difference between two adjacent frames of the video data.

34. The program product as defined in claim 32, wherein the frames of video data comprise frames compressed with respect to original frames, and the metadata information specifies the mean squared error for each compressed frame as compared to the corresponding original frame.

35. The program product as defined in claim 29, further including:
constructing a decision tree with nodes that specify the combinations of operation categories and operation parameters within the operation categories; and
determining estimated received video quality for each of the decision tree nodes.

36. The program product as defined in claim 35, wherein constructing a decision tree comprises analyzing the available customizing operations for each video data frame of the digital video content by means of operations comprising:
generating child nodes comprising option nodes for the available customizing operations;
pruning the child nodes in accordance with quantization level.

37. The program product as defined in claim 36, wherein pruning includes pruning the child nodes in accordance with incremental quantization level relative to a current quantization level of the video data frame.

38. The program product as defined in claim 36, wherein pruning includes pruning the child nodes in accordance with a range of quantization level of the available customizing operations for the video data frame.

39. The program product as defined in claim 29, wherein estimating received video quality comprises consideration of frame type, including video P-frames and I-frames.

40. The program product as defined in claim 39, further including consideration of encoding distortion of the P-frames and I-frames.

41. The program product as defined in claim 29, wherein estimating received video quality comprises consideration of frame rate.

42. The program product as defined in claim 41, wherein the available customizing operations include skipping a video data frame in the digital video content.
